(19) United States
(12) Patent Application Publication
(10) Pub. No.: US 2026/0296390 A1
(43) Pub. Date: Oct. 1, 2026

(54) DRIVING ASSISTANCE DEVICE AND DRIVING ASSISTANCE METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yosuke MIYAMOTO, Tokyo (JP); Yasuo OKUDA, Tokyo (JP); Yoshikatsu ODA, Nagoya-shi (JP); Tatsuya NISHI, Okazaki-shi (JP); Naoki HASHIMOTO, Kasugai-shi (JP)

(21) Appl. No.: 19/629,672

(22) Filed: Mar. 26, 2026

(30) Foreign Application Priority Data
Mar. 28, 2025 (JP) 2025-055024

(51) Int. Cl. B60T 8/58; B60T 7/22; B60T 8/171; B60T 8/172; B60W 10/06; B60W 10/184; B60W 30/18

(52) U.S. Cl. CPC B60T 8/58; B60T 7/22; B60T 8/171; B60T 8/172; B60W 10/06; B60W 10/184; B60W 30/18027; B60T 2201/022; B60T 2210/32; B60T 2220/04; B60T 2250/04; B60W 2520/10; B60W 2710/06; B60W 2710/18

(57) ABSTRACT

A driving assistance device performs driving assistance for a mobile object. The driving assistance device includes: an automatic stopping control unit configured to stop the mobile object by applying brake force in a case that a collision between the mobile object and an obstacle around the mobile object is predicted, and keeps the mobile object stationary for a predetermined period starting from the moment the mobile object is stopped, and a speed control unit configured to, after the predetermined period has elapsed, in a case that a predetermined condition is satisfied, control at least one of a driving force and a brake force of the mobile object to limit a speed of the mobile object to a first speed. The predetermined condition indicates that an accidental pedal depression has occurred, the accidental pedal depression being an operation by a driver of the mobile object mistakenly depressing an accelerator with the intention of depressing a brake pedal.

### CROSS-REFERENCE TO RELATED APPLICATIONS

The present application claims priority to Japanese Application No. 2025-55024, filed on Mar. 28, 2025. The contents of this application are incorporated herein by reference in their entirety.

### BACKGROUND

### 1. Technical Field

This disclosure relates to a driving assistance device and a driving assistance method.

### 2. Related Art

Various techniques have been proposed to suppress sudden vehicle acceleration caused by accidental pedal depression on an accelerator after automatic stopping operation. The accidental pedal depression is an operation where the driver mistakenly presses the accelerator instead of the brake pedal. JP7572148B2 discloses a technique where, in a case where the accidental pedal depression occurs when control to keep the vehicle stationary is released, generating driving force for the vehicle lower than the driving force corresponding to the accelerator operation amount. JP7517511B2 discloses a technique that continues to perform control to keep the vehicle stationary when the accidental pedal depression has occurred after the control to keep the vehicle stationary is performed. The technique described in JP7517511B2 suppresses the departure of the vehicle itself due to accidental pedal depression after automatic brake control.

### SUMMARY

In the technology described in JP7572148B2, there is a risk that the vehicle may continue accelerating when the accidental pedal depression continues. In the technology described in JP7517511B2 there is a risk that the vehicle cannot depart when a false determination of the accidental pedal depression occurrence is made, even though the driver intends to start the vehicle. Thus, there is room for improvement in technologies suppressing sudden starts after automatic brake control. Such problems exist not only in vehicles but also in other mobile objects.

The present disclosure may be realized in the following forms.

According to one embodiment of the present disclosure, a driving assistance device (1) is provided. The driving assistance device performs driving assistance for a mobile object. The driving assistance device comprises: an automatic stopping control unit configured to stop the mobile object by applying brake force in a case that a collision between the mobile object and an obstacle around the mobile object is predicted, and keeps the mobile object stationary for a predetermined period starting from the moment the mobile object is stopped, and a speed control unit configured to, after the predetermined period has elapsed, in a case that a predetermined condition is satisfied, control at least one of a driving force and a brake force of the mobile object to limit a speed of the mobile object to a first speed. The predetermined condition indicates that an accidental pedal depression, that is an operation by a driver of the mobile object mistakenly depressing an accelerator with the intention of depressing a brake pedal.

According to this embodiment of the driving assistance device, the speed control unit controls at least one of a driving force and a brake force of the mobile object to limit the speed of the mobile object to a first speed, after the predetermined period has elapsed, in a case that a predetermined condition is satisfied. Therefore, by setting the first speed to a relatively low speed, for example 20 km/h or less, it is possible to reduce impact even if the mobile object collides with an obstacle. Furthermore, even if a false determination is made that accidental pedal depression has occurred, the mobile object is driven at speeds up to the first speed. This allows the mobile object to move even if, for example, the automatic brake of the mobile object activates within a railroad crossing and a false determination is made that accidental pedal depression is occurring.

### BRIEF DESCRIPTION OF THE DRAWING

FIG. 1 is a block diagram showing schematic configuration of a driving assistance device according to an embodiment.

FIG. 2 is a flowchart showing procedure of determining processing for an accidental pedal depression.

FIG. 3 is a flowchart showing procedure for releasing determined state.

FIG. 4 is a graph showing a relationship between an upper limit of driving force and the vehicle speed.

FIG. 5 is a flowchart showing procedure of speed control processing.

FIG. 6 is a graph showing a relationship between magnitude of the brake force and the vehicle speed.

FIG. 7 is a flowchart showing the procedure of speed control processing according to a third embodiment.

FIG. 8 is a graph showing a relationship between un upper limit of driving force and an elapsed time.

### DETAILED DESCRIPTION OF THE PREFERRED EMBODIMENTS

### A. First Embodiment

### <Overview of Driving Assistance Device 1>

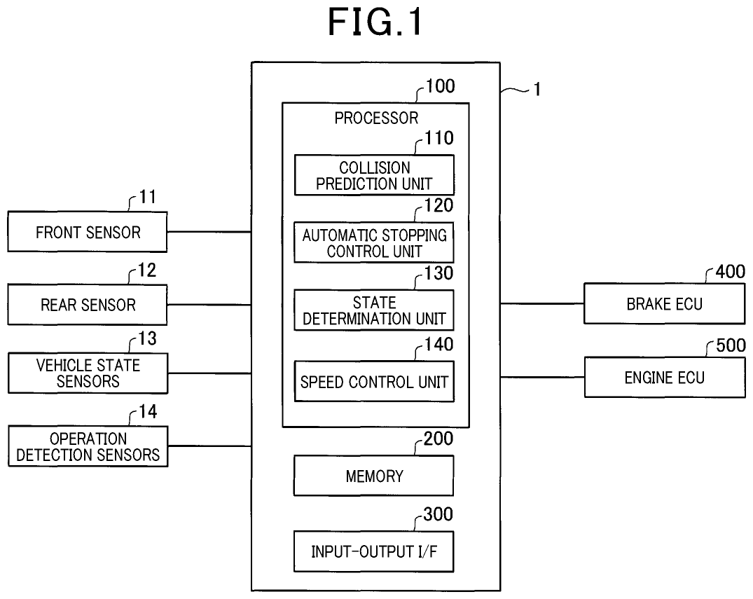

A driving assistance device 1 shown in FIG. 1 is mounted to a vehicle. The driving assistance device 1 automatically stops the vehicle when collision between the vehicle and surrounding obstacle is predicted or detected. The driving assistance device 1 controls speed of the vehicle (hereinafter, referred to as vehicle speed) when an accidental pedal depression occurs at the time the vehicle is automatically stopped.

The obstacle in this disclosure is an object that may collide with the vehicle. Examples of the obstacle include pedestrians, bicycles, animals, other vehicles different from the vehicle equipped with driving assistance device 1, structures, utility poles, trees, signs, etc.

### <Sensor Configuration>

As shown in FIG. 1, the driving assistance device 1 is connected to multiple sensors mounted to the vehicle. Various signals are input from the multiple sensors via an input/output interface (I/F) 300. The multiple sensors may include a front sensor 11, a rear sensor 12, vehicle state sensors 13, and operation detection sensors 14.

Each of the front sensor 11 and the rear sensor 12 detects obstacles existing around the vehicle. Each of the front sensor 11 and the rear sensor 12 may be, for example, a camera or a ranging device. The ranging device may include, for example, millimeter-wave radar, LiDAR (Light Detection and Ranging), etc. Each of the front sensor 11 and the rear sensor 12 may be configured by combining multiple types of sensors. The front sensor 11 may be, for example, positioned at the center of the front bumper of the vehicle. The rear sensor 12 may be, for example, positioned at the center of the rear bumper of the vehicle. Detection results of the front sensor 11 and the rear sensor 12 are transmitted to the driving assistance device 1 at predetermined intervals.

Each of the vehicle state sensors 13 detects various information related to the vehicle. The vehicle state sensors 13 may include, for example, a vehicle speed sensor that detects vehicle speed, an acceleration sensor that detects acceleration of the vehicle, and a yaw rate sensor that detects yaw rate of the vehicle. Detection results of each of the vehicle state sensors 13 are transmitted to the driving assistance device 1 at predetermined intervals.

Each of the operation detection sensors 14 detects an operation amount performed by the vehicle driver. The operation detection sensors 14 may include, for example, an accelerator sensor that detects an amount of accelerator depression, a brake operation amount sensor that detects an amount of brake pedal depression, a steering angle sensor that detects a steering angle, a steering angle torque sensor that detects a steering torque, a turn signal sensor that detects a turn signal operation status, and a shift position sensor that detects shift position. Detection results of each of the operation detection sensors 14 are transmitted to the driving assistance device 1 at predetermined intervals.

### <Configuration of Brake ECU 400>

As shown in FIG. 1, a brake ECU 400 is connected to driving assistance device 1 and receives signals from driving assistance device 1. The brake ECU 400 is mounted to the vehicle. The brake ECU 400 is connected to a brake actuator of the vehicle. The brake actuator adjusts hydraulic pressure of the brake mechanism attached to the wheels based on instructions from the brake ECU 400. Increasing the hydraulic pressure of the brake mechanism applies braking force to the vehicle. The braking force is adjusted by controlling the magnitude of the hydraulic pressure in the brake mechanism.

The brake ECU 400 operates the brake actuator based on the degree of brake pedal depression detected by the brake operation amount sensor. Furthermore, the brake ECU 400 operates the brake actuator when it receives instructions from the driving assistance device 1. Details are described later.

### <Configuration of Engine ECU 500>

As shown in FIG. 1, an engine ECU 500 is connected to the driving assistance device 1 and receives signals from the driving assistance device 1. The engine ECU 500 is mounted to the vehicle. The engine ECU 500 is connected to a engine actuator of the vehicle. The engine actuator changes the operating state of the engine. For example, the engine actuator may change opening degree of a throttle valve. By controlling the engine actuator, the engine ECU 500 adjusts the driving force applied to the vehicle.

The engine ECU 500 controls the engine actuator based on the amount of accelerator depression detected by the accelerator sensor and the vehicle speed detected by the vehicle speed sensor. The engine ECU 500 controls the engine actuator such that a larger driving force is generated as the amount of accelerator depression increases. Furthermore, the engine ECU 500 controls the engine actuator such that a larger driving force is generated as the vehicle speed decreases. Additionally, the engine ECU 500 controls the engine actuator in response to instructions from the driving assistance device 1. Details are described later.

### <Configuration of the Driving Assistance Device 1>

The driving assistance device 1 comprises a processor 100, a memory 200, and the input/output interface 300. The driving assistance device 1 may be configured as part of an ECU (Electronic Control Unit) that performs various vehicle controls.

The processor 100 functions as a collision prediction unit 110, an automatic stopping control unit 120, a state determination unit 130, and a speed control unit 140 by executing the program stored in the memory 200.

### <Function of the Collision Prediction Unit 110>

The collision prediction unit 110 predicts whether an obstacle detected by the front sensor 11 or the rear sensor 12 will collide with the vehicle. The collision prediction unit 110 predicts whether the obstacle and the vehicle will collide based on a predicted trajectory of the obstacle and a predicted trajectory of the vehicle. The predicted trajectory of the obstacle is calculated based on historical changes in the position of the obstacle. The predicted trajectory of the vehicle is calculated based on the vehicle speed and the yaw rate of the vehicle. The collision prediction unit 110 may predict a collision between the obstacle and the vehicle in a case that parts of the predicted trajectories of the obstacle and the predicted trajectory of the vehicle intersect at the same time and predict no collision when they do not intersect. The calculation of the trajectory may be performed by any method, not limited to the above method. When the obstacle is stationary, the collision prediction unit 110 predicts whether the obstacle and the vehicle will collide by determining whether the predicted trajectory of the vehicle passes through the position of the obstacle.

### <Function of the Automatic Stopping Control Unit 120>

When the collision prediction unit 110 predicts that the obstacle and the vehicle will collide with, the automatic stopping control unit 120 automatically stops the vehicle by applying brake force. Specifically, the automatic stopping control unit 120 outputs a control signal to the brake ECU 400 instructing it to increase pressure in the brake mechanism. This applies brake force to the vehicle regardless of whether the driver presses the brake pedal. The applied braking force is sufficient to either avoid collision between the obstacle and the vehicle or reduce impact force when they collide. The braking force is calculated based on relative speed and relative distance between the obstacle and the vehicle. The automatic stopping control unit 120 does not apply brake force to the vehicle when the collision prediction unit 110 predicts no collision between the obstacle and the vehicle.

After automatically stopping the vehicle, the automatic stopping control unit 120 keeps the vehicle stationary for a predetermined period. This control is referred to as “stop hold control”. The stop hold control is performed to prevent the vehicle from suddenly accelerating due to a panicked driver depressing the accelerator after the vehicle has automatically stopped. The predetermined period may be set, for example, to 10 seconds. The predetermined period may be set to any value other than 10 seconds. Information regarding the predetermined period is stored in memory 200. In the stop hold control, the automatic stopping control unit 120 outputs a control signal to the brake ECU 400 instructing it to maintain a state of increased hydraulic pressure in the brake mechanism, and outputs a control signal to the engine ECU 500 to prohibit the generation of the driving force. Hereinafter, the control by the automatic stopping control unit 120 to stop the vehicle and the stop hold control are collectively referred to as “automatic brake control”.

The automatic stopping control unit 120 releases the stop hold control after the predetermined period has elapsed. This allows the vehicle to be in a state ready for departure.

### <Function of the State Determination Unit 130>

The state determination unit 130 determines whether the accidental pedal depression has occurred. The accidental pedal depression is an operation where the driver mistakenly presses the accelerator instead of the brake pedal. The state determination unit 130 determines that the accidental pedal depression has occurred when a predetermined condition indicating the accidental pedal depression has occurred is satisfied. The predetermined condition is that both a first condition C1 and a second condition C2 are satisfied. The state determination unit 130 determines that accidental pedal depression has not occurred in a case that at least one of the first condition C1 and the second condition C2 is not satisfied. Information of the first condition C1 and the second condition C2 are predetermined and stored in memory 200. The first condition C1 and the second condition C2 are as follows.

The first condition C1: Depression amount of the accelerator AP is greater than or equal to a predetermined first threshold AP1.

The second condition C2: Rate of depression amount of the accelerator APV is greater than or equal to a predetermined threshold APVc.

The depression amount of the accelerator AP in the first condition C1 is detected by the accelerator sensor. The rate of depression amount of the accelerator APV in the second Condition C2 is calculated based on change in the depression amount of the accelerator AP per unit time. The first threshold AP1 and threshold APVc in the first condition C1 and the second condition C2, respectively, are predetermined values for detecting the accidental pedal depression. The first threshold AP1 and threshold APVc are determined based on experimentally obtained values for the accelerator depression amount and accelerator depression rate when accidental pedal depression has occurred. Using such first threshold AP1 and threshold APVc allows for appropriate detection of sudden accelerator depressions caused by accidental pedal depression.

The state determination unit 130 determines that the accidental pedal depression has occurred when both the first condition C1 and the second condition C2 are satisfied. After determining that the accidental pedal depression has occurred, the state determination unit 130 maintains this determination until the driver releases the accelerator operation. The release of the accelerator operation may include not only an operation amount of the accelerator operation amount becoming zero, but also an operation amount of the accelerator falling below a predetermined threshold.

### <Accidental Stepping Determination Processing>

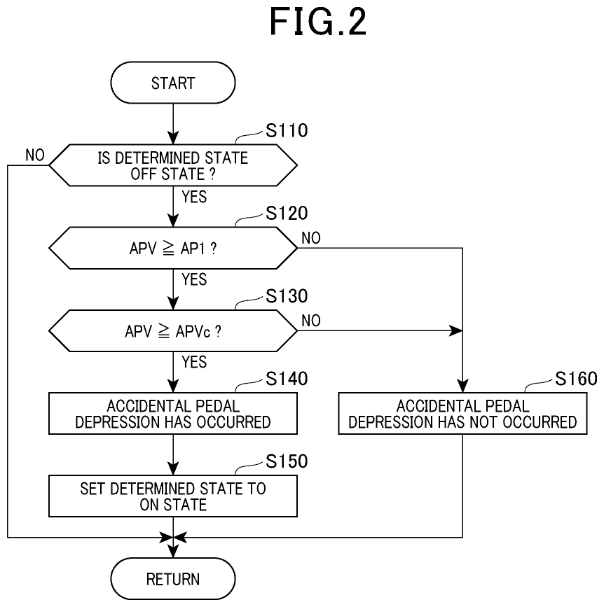

The accidental pedal depression determination processing shown in a flowchart of FIG. 2 provides a more specific implementation of the processing performed by the state determination unit 130. The accidental pedal depression determination processing is repeatedly performed at predetermined intervals when an ignition switch of the vehicle is turned on.

The state determination unit 130 determines whether a determined state is the OFF state (Step S110). “Determined state is the OFF state” means it has been determined that the accidental pedal depression has not occurred. On the other hand, “determined state is the ON state” means it has been determined that accidental pedal depression has occurred. The processing in step S110 is configured to suppress redundant performance of the detection processing when determined state is already the ON state. In a case that the determined state is the ON state (step S110: NO), the accidental pedal depression determination processing terminates. The initial state of the determined state is OFF state.

In a case that the determined state is the OFF state (Step S110: YES), the state determination unit 130 determines whether both the first condition C1 and the second condition C2 are satisfied in the respective processing of Step S120 and Step S130. Step S120 corresponds to the first condition C1, and Step S130 corresponds to the second condition C2. The processing of step S120 and step S130 may be performed in reverse order or in parallel.

The state determination unit 130 determines that the accidental pedal depression has not occurred (Step S160) when a negative determination is made in at least one of Steps S120 and S130. In this case, the state determination unit 130 maintains the determined state to the OFF state.

In a case that a positive determination is made in both step S120 and step S130, the state determination unit 130 determines that accidental pedal depression has occurred (step S140). In this case, state determination unit 130 sets the determined state to the ON state (step S150).

### <Determined State Release Processing>

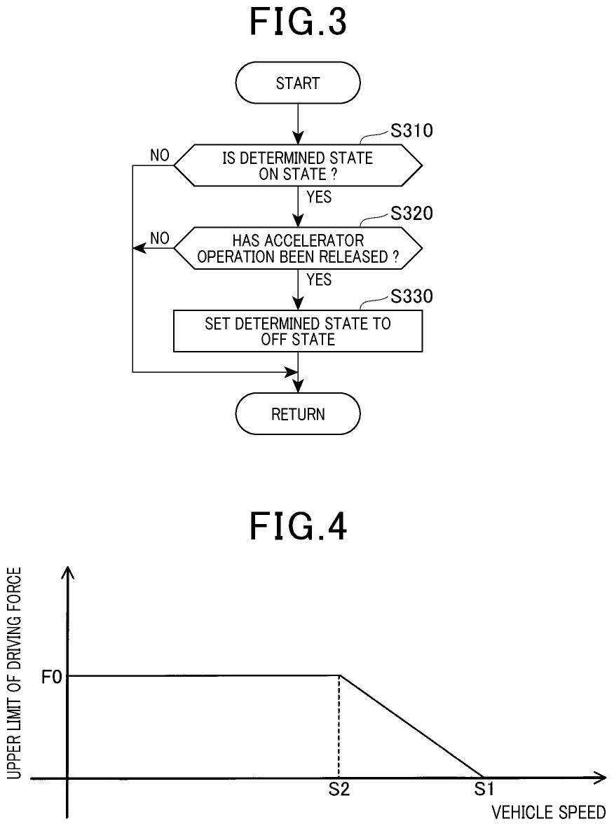

The determined state release processing shown in FIG. 3 is performed to return the determined state from the ON state to the OFF state. The determined state release processing is repeatedly performed at a predetermined cycle in parallel with the accidental pedal depression determination processing shown in FIG. 2.

As shown in FIG. 3, the state determination unit 130 determines whether the determined state is the ON state (Step S310). In a case that the determined state is not the ON state (Step S310: NO), the state determination unit 130 terminates the determined state release processing. In a case that the determined state is the ON state (Step S310: YES), the state determination unit 130 determines whether the accelerator operation has been released (Step S320). In a case that the accelerator operation has not been released (Step S320: NO), the state determination unit 130 terminates the determined state release processing. In this case, the state determination unit 130 maintains determined state to the ON state. In a case that the accelerator operation has been released (Step S320: YES), the state determination unit 130 sets the determined state to the OFF state (Step S330).

### <Function of the Speed Control Unit 140>

After the stop hold control by the automatic stopping control unit 120 is released, in a case that the state determination unit 130 determines that the predetermined condition indicating that the accidental pedal depression has occurred is satisfied, the speed control unit 140 controls at least one of the driving force and the brake force to limit the vehicle speed to a first speed or below. In other words, after the stop hold control is released, when the accidental pedal depression has occurred, the speed control unit 140 controls at least one of the driving force and the brake force, such that the speed does not exceed the first speed, which is set as an upper limit speed. The first speed is set to a level where the impact generated when the vehicle traveling at that speed collides with an obstacle is relatively small. The first speed may be, for example, 15 km/h. The first speed may also be any speed different from 15 km/h. Information about the first speed is stored in the memory 200. In this embodiment, the speed control unit 140 controls the driving force to limit the vehicle speed. This control is performed by the speed control unit 140 outputting a control signal to the engine ECU 500, instructing it to generate a driving force that does not exceed the first speed.

As shown in FIG. 4, the speed control unit 140 in this embodiment controls driving force in two different ways. The vertical axis of FIG. 4 indicates the upper limit of the driving force of the vehicle, while the horizontal axis indicates the vehicle speed. In this embodiment, the method for setting the upper limit of the driving force differs depending on whether the vehicle speed is less than a second speed S2 or between the first speed S1 and the second speed S2. When the vehicle speed is less than the second speed S2, the speed control unit 140 sets the maximum upper limit F0 as the upper limit of the driving force, limiting driving force of the vehicle to be less than or equal to the maximum upper limit F0. That is, when the vehicle speed is less than the second speed S2, the upper limit of the driving force is set to a constant value. The second speed S2 is smaller than the first speed S1 and is predetermined. The second speed S2 may be, for example, 10 km/h. The second speed S2 may also be any value different from 10 km/h. Any arbitrary value may be set for the maximum upper limit F0. The maximum upper limit F0 is, for example, experimentally determined beforehand as the driving force capable of suppressing sudden acceleration. Information of the second speed S2 and the maximum upper limit F0 is stored in the memory 200.

When the vehicle speed is between the first speed S1 and the second speed S2, the speed control unit 140 sets the upper limit of the driving force smaller as the vehicle speed increases. “between the first speed S1 and the second speed S2” may or may not include the boundary values of the first speed S1 and the second speed S2. In this embodiment, the upper limit of the driving force between the first speed S1 and the second speed S2 changes linearly such that the upper limit at the first speed S1 becomes zero and the upper limit at the second speed S2 becomes the maximum upper limit F0. The upper limit of the driving force between the first speed S1 and the second speed S2 is smaller than the maximum upper limit F0. The speed control unit 140 controls the driving force such that it does not exceed the upper limit of driving force set in this manner.

### <Speed Control Processing>

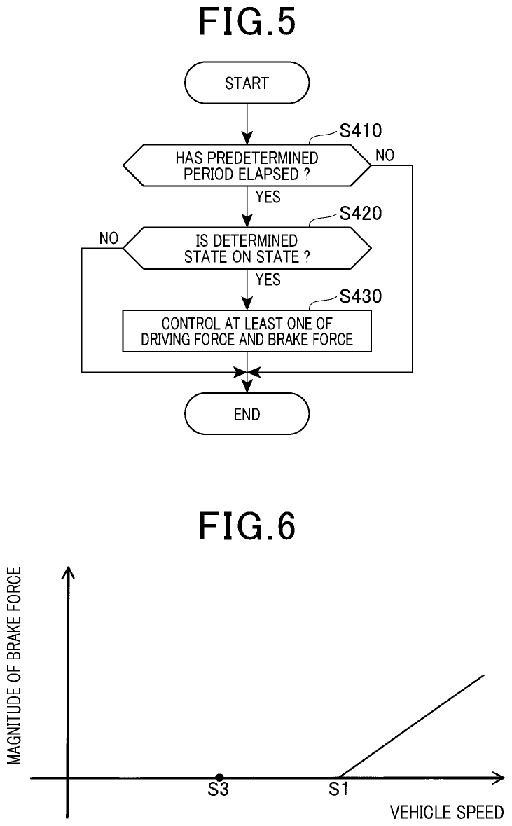

The speed control processing shown in FIG. 5 is performed to limit the vehicle speed when the accidental pedal depression occurs after the automatic brake control. The speed control process is performed after the automatic brake control.

The speed control unit 140 determines whether the predetermined period for the stop hold control by the automatic stopping control unit 120 has elapsed (Step S410). In a case that the predetermined period has not elapsed (Step S410: NO), the speed control unit 140 terminates the speed control process. In a case that the predetermined period has elapsed (Step S410: YES), the speed control unit 140 determines whether the determined state is the ON state (Step S420). In a case that the determined state is the ON state (Step S420: YES), the speed control unit 140 controls at least one of the driving force and the brake force such that the vehicle speed does not exceed the first speed S1 (Step S430). In a case that the determined state is not the ON state (Step S420: NO), the speed control processing is terminated.

According to the first embodiment driving assistance device 1 described above, the speed control unit 140 controls the driving force such that the vehicle speed does not exceed the first speed S1 when the predetermined condition for the accidental pedal depression is satisfied after the predetermined period of the stop hold control has elapsed. Therefore, by setting the first speed S1 to a relatively low speed, such as 20 km/h or less, even if the accidental pedal depression continues and a collision occurs between the vehicle and an obstacle, the impact is suppressed. Furthermore, even if the accidental pedal depression is erroneously detected as having occurred, the vehicle is driven at speeds up to the first speed S1. This allows the vehicle to move even if the automatic brake activates within a railroad crossing, for example, and the accidental pedal depression is erroneously detected as having occurred.

According to driving assistance device 1 of the first embodiment, when the predetermined condition for the accidental pedal depression is satisfied after the predetermined period of the stop hold control has elapsed while the vehicle speed is between the first speed S1 and the second speed S2, the speed control unit 140 sets the upper limit of the driving force smaller as the vehicle speed increases. Therefore, as the vehicle approaches the first speed S1 during the continuous accidental pedal depression, the vehicle acceleration is suppressed. Compared with a configuration that abruptly reduces the driving force upon reaching the first speed, it is possible to reduces the impact caused by acceleration changes when the vehicle speed reaches the first speed S1.

Furthermore, according to driving assistance device 1 of the first embodiment, the speed control unit 140 controls the driving force of the vehicle such that it does not exceed the maximum upper limit F0 when the predetermined condition for the accidental pedal depression is satisfied after the predetermined period of the stop hold control has elapsed and the vehicle speed is less than the second speed S2. Therefore, by setting the maximum upper limit F0 to a driving force that suppresses sudden acceleration, sudden acceleration of the vehicle due to the accidental pedal depression is suppressed.

### B. Second Embodiment

The driving assistance device 1 according to the second embodiment differs from the first embodiment in that the control of the vehicle speed by the speed control unit 140 is performed using brake force. The configurations not described below are the same as those in the driving assistance device 1 of the first embodiment.

In the second embodiment, the speed control unit 140 applies brake force to the vehicle after the predetermined period of the stop hold control has elapsed, in a case that the predetermined condition is satisfied and the vehicle is on a downhill slope, such that the vehicle speed does not exceed the first speed S1. In this disclosure, “the vehicle is on a downhill slope” includes both the state where the vehicle is traveling down the slope and the state where the vehicle is stopped on the downhill slope by automatic braking. When the vehicle is on a downhill slope, controlling only the driving force may cause the vehicle to continue accelerating. In contrast, the speed control unit 140 of the second embodiment controls the vehicle speed by applying the braking force. Determining whether the vehicle is on a downhill slope is performed based on detection results of the acceleration sensor in the vehicle state sensor 13. This determination may be performed by any method. For example, it may be performed using map information. Applying brake force is performed by transmitting a control signal to the brake ECU 400.

As shown in FIG. 6, in this embodiment, the speed control unit 140 applies brake force to the vehicle when the vehicle speed reaches the first speed S1. The vertical axis in FIG. 6 indicates the magnitude of the brake force, and the horizontal axis indicates the vehicle speed. In this embodiment, the speed control unit 140 applies a larger braking force as the vehicle speed increases when the vehicle speed exceeds the first speed S1. The braking force may increase linearly. When traveling downhill, the vehicle speed may exceed the first speed S1, which is the upper limit speed. Even in such cases, by applying a greater brake force as the vehicle speed increases, the speed is controlled to promptly prevent exceeding the first speed S1.

Furthermore, in this embodiment, the speed control unit 140 generates brake preload when the vehicle speed increases and reaches a third speed S3. “Brake preload” means increasing the hydraulic pressure in the brake mechanism to a level where no braking force is generated, or only a slight braking force is generated. Generating the brake preload is achieved by transmitting a control signal to the brake ECU 400, activating the brake actuator, and adjusting the hydraulic pressure in the brake mechanism. The third speed S3 is smaller than the first speed S1 and is predetermined. The third speed S3 is, for example, 10 km/h. The third speed S3 may be any value other than 10 km/h. The third speed S3 may be the same value as the second speed S2 described above, or it may be a different value.

According to the second embodiment of the driving assistance device 1 described above, when the predetermined condition for the accidental pedal depression is satisfied after the predetermined period of the stop hold control has elapsed while the vehicle is on a downhill slope, the speed control unit 140 applies the brake force to the vehicle to ensure its speed does not exceed the first speed S1. Thus, even when the vehicle is on a downhill slope and the vehicle speed is not controlled enough by the driving force control alone, the vehicle speed is controlled to not exceed the first speed S1.

Furthermore, according to driving assistance device 1 of the second embodiment, the speed control unit 140 applies a braking force to the vehicle that increases as the vehicle speed increases when the predetermined condition for the accidental pedal depression is satisfied after the predetermined period of the stop hold control has elapsed while the vehicle is on a downhill slope and the vehicle speed exceeds the first speed S1. Compared to a configuration that applies a constant braking force regardless of vehicle speed, this allows the vehicle speed to be reduced to below the first speed S1 in a relatively short time.

Furthermore, according to driving assistance device 1 of the second embodiment, the speed control unit 140, when the predetermined condition for the accidental pedal depression is satisfied after the predetermined period of the stop hold control has elapsed while the vehicle is on a downhill slope and the vehicle speed reaches the third speed S3 that is less than the first speed S1, generates the brake preload. Compared to a configuration that does not generate the brake preload, this allows the brake force to be applied promptly when the vehicle speed reaches the first speed S1. This further suppresses the vehicle speed from exceeding the first speed S1.

### C. Third Embodiment

The driving assistance device 1 according to the third embodiment differs from the first embodiment in that the speed control unit 140 further performs driving force control even when the accidental pedal depression has not occurred. Configurations not described below are the same as those in the driving assistance device 1 of the first embodiment. The driving assistance device 1 of the third embodiment may be used in combination with the driving assistance device 1 of the second embodiment.

When the predetermined period of the stop hold control has elapsed, the speed control unit 140, in a case that the state determination unit 130 determines that the accidental pedal depression has not occurred, sets the upper limit of the driving force higher as the elapsed time since the period ended is longer. Then the speed control unit 140 controls the driving force such that it does not exceed the upper limit. Therefore, the longer the elapsed time since the period ended, the larger the vehicle speed is allowed.

### <Speed Control Processing of the Third Embodiment>

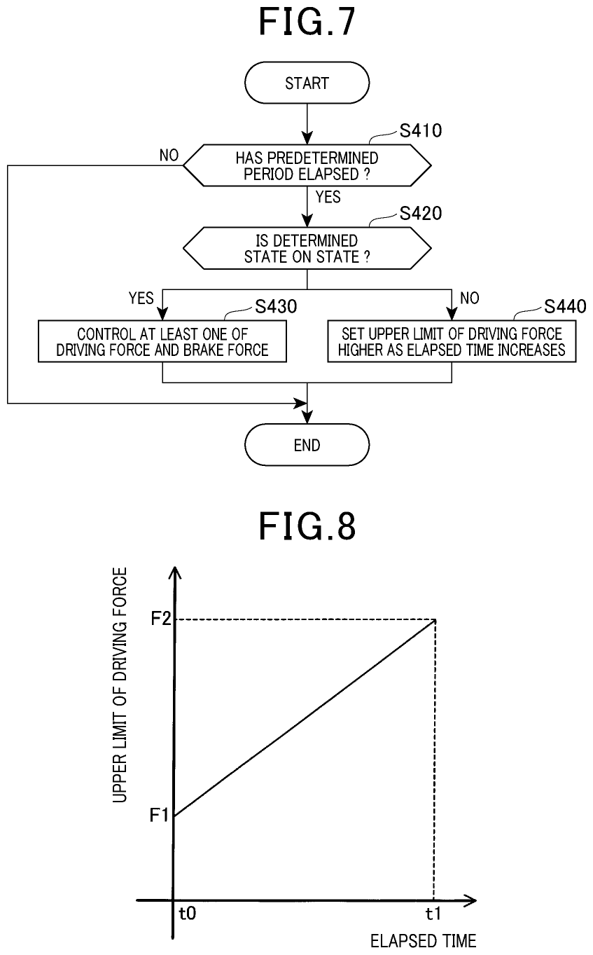

The speed control processing of the third embodiment shown in FIG. 7 differs from the first embodiment shown in FIG. 5 in the processing performed when a negative determination is made in step S420. Since the other processing is the same as the first embodiment, detailed description is omitted.

When the state determination unit 130 determines that determined state is not the ON state (step S420: NO), the state determination unit 130 sets the upper limit of the driving force higher as the elapsed time increases and controls the driving force such that it does not exceed the upper limit (S440). The upper limit of the driving force is explained using FIG. 8.

As shown in FIG. 8, the upper limit of the driving force in this embodiment is set to change linearly. In FIG. 8, the vertical axis indicates the upper limit of the driving force, and the horizontal axis indicates the elapsed time. Furthermore, the time when the stop hold control has been continuously applied is defined as t0. At the elapsed time t0, the upper limit of the driving force is set to F1. The upper limit F1 is set to any value sufficient to suppress sudden acceleration. At any elapsed time t1 greater than t0, the upper limit of the driving force is set to F2, which is a value greater than F1. Thus, the longer the elapsed time, the larger the upper limit is set.

According to the driving assistance device 1 of the third embodiment described above, when the stop hold control continues for a period and the occurrence condition for accidental pedal depression is not satisfied, when the predetermined condition for the accidental pedal depression is satisfied after the predetermined period of the stop hold control has elapsed, the speed control unit 140 sets the upper limit of the driving force higher as the elapsed time since the period ended of the stop hold control is longer. Then the speed control unit 140 controls the driving force such that it does not exceed the upper limit. Compared to a configuration where the upper limit of the driving force is constant, this allows the vehicle to be driven at gradually increasing speeds while suppressing sudden starts.

### D. Other Embodiments

(D1) In the first embodiment described above, the speed control unit 140 may set the upper limit of the driving force arbitrarily. For example, when the vehicle speed is between the first speed S1 and the second speed S2, the upper limit of the driving force may change not only linearly but also quadratically or in a step function manner. The upper limit of the driving force may be constant regardless of the speed.
(D2) In the second embodiment described above, the speed control unit 140 may apply the brake force of any magnitude when the vehicle is on a downhill slope and the vehicle speed exceeds the first speed S1. The brake force may change not only linearly but also quadratically or stepwise. The brake force may be constant.
(D3) In the third embodiment described above, the upper limit of the driving force is set to change linearly, but it is not limited thereto. The upper limit of the driving force may change not only linearly but also quadratically or stepwise.
(D4) In the third embodiment, the speed control unit 140 generates the brake preload when the vehicle is on a downhill slope and the vehicle speed reaches the third speed S3, but it is not limited thereto. The speed control unit 140 may be configured not to generate brake preload.
(D5) In each of the above embodiments, the predetermined condition may be changed. The predetermined condition may be that all the first condition C1, the second condition C2, and a third condition C3 are satisfied. The third condition C3 may be, for example, that within a certain period after the timing that the first condition C1 and the second condition C2 are satisfied, the depression amount of the accelerator AP reaches or exceeds a second threshold AP2, which is greater than the first threshold AP1. The certain period may be, for example, 0.5 seconds. The certain period may be any time other than 0.5 seconds. When the accidental pedal depression has occurred, in addition to the initial depression, the accelerator may be depressed even more strongly. Setting the third condition C3 enables detection of such a strong depression.

Furthermore, the predetermined condition may be that all the first condition C1, the second condition C2, the third condition C3, and a fourth condition C4 are satisfied. The fourth condition C4 may be, for example, that an existence of an obstacle is detected ahead of the vehicle. When the accelerator is depressed despite an obstacle being present ahead of the vehicle, the accidental pedal depression is highly likely to occur. Setting the fourth condition C4 enables detection of the accidental pedal depression in such situations. The predetermined condition may be that at least one of the first condition C1, the second condition C2, the third condition C3, and the fourth condition C4 are satisfied.
(D6) In each of the above embodiments, the speed control unit 140 may control the driving force to be constant when the predetermined condition is satisfied after the hold control period has elapsed and the vehicle speed is less than the second speed S2. The driving force set here is a relatively small driving force that prevents the vehicle from making a sudden start. This configuration suppresses the vehicle from continuing to travel at a relatively large acceleration after starting by the accidental pedal depression.
(D7) In the above embodiment, the driving assistance device 1 was mounted to a vehicle, but it is not limited thereto. The driving assistance device 1 may be mounted to any mobile object. Examples of mobile object include ships, aircraft, and so-called flying cars.
(D8) The driving assistance device 1 and methods described herein may be implemented by a dedicated computer provided by configuring a processor and memory programmed to execute one or more functions embodied by a computer program. Alternatively, the driving assistance device 1 and methods described herein may be implemented by a dedicated computer provided by configuring a processor using one or more dedicated hardware logic circuits. Alternatively, the driving assistance device 1 and methods described herein may be implemented by one or more dedicated computers configured with a combination of a processor and memory programmed to execute one or more functions, and one or more processors configured by one or more hardware logic circuits. Furthermore, the computer program may be stored on a computer-readable, non-transitory tangible medium as instructions executable by a computer.

The present disclosure is not limited to the embodiments described above and may be realized in various configurations within the scope of the invention without departing from its spirit. For example, the technical features in each embodiment corresponding to the technical features described in the Summary of the Invention may be appropriately substituted or combined to solve some or all of the above-mentioned problems or to achieve some or all of the above-mentioned effects. Furthermore, if a technical feature is not described herein as essential, it may be omitted as appropriate. The present disclosure may be embodied, for example, as a driving support method, a speed control method, a computer program for implementing these methods, a non-transitory storage medium recording such a computer program, and the like.

The present disclosure may be embodied, for example, in the following forms.

### [Form 1]

A driving assistance device (1) configured to perform driving assistance for a mobile object, comprising:
an automatic stopping control unit (120) configured to stop the mobile object by applying brake force in a case that a collision between the mobile object and an obstacle around the mobile object is predicted, and keeps the mobile object stationary for a predetermined period starting from the moment the mobile object is stopped; and
a speed control unit (140) configured to, after the predetermined period has elapsed, in a case that a predetermined condition is satisfied, control at least one of a driving force and a brake force of the mobile object to limit a speed of the mobile object to a first speed,
wherein the predetermined condition indicates that an accidental pedal depression has occurred, the accidental pedal depression being an operation by a driver of the mobile object mistakenly depressing an accelerator with the intention of depressing a brake pedal.

### [Form 2]

The driving assistance device according to Form 1, wherein
the speed control unit is configured to, after the predetermined period has elapsed, in a case that the predetermined condition is satisfied and a speed of the mobile object is between the first speed and a second speed lower than the first speed, set an upper limit of the driving force smaller as the speed of the mobile object increases and limit the driving force to the upper limit.

### [Form 3]

The driving assistance device according to Form 2, wherein
the speed control unit is configured to, after the predetermined period has elapsed, in a case that the predetermined condition is satisfied and the speed of the mobile object is less than the second speed, limit the driving force to a predetermined maximum upper limit.

### [Form 4]

The driving assistance device according to Form 2, wherein
the speed control unit is configured to, after the predetermined period has elapsed, in a case that the predetermined condition is satisfied and the speed of the mobile object is less than the second speed, keep the driving force constant.

### [Form 5]

The driving assistance device according to Form 1, wherein
the speed control unit is configured to, after the predetermined period has elapsed, in a case that the predetermined condition is satisfied and the mobile object is on a downhill slope, apply the brake force to the mobile object to limit the speed of the mobile object to the first speed.

### [Form 6]

The driving assistance device according to Form 5, wherein
the speed control unit is configured to, after the predetermined period has elapsed, in a case that the predetermined condition is satisfied, the mobile object is on a downhill slope, and the speed of the mobile object exceeds the first speed, apply brake force to the mobile object that is greater as the speed of the mobile object is greater.

### [Form 7]

The driving assistance device according to Forms 5 or 6, wherein
the speed control unit, after the predetermined period has elapsed, in a case that the predetermined condition is satisfied, the mobile object is on a downhill slope, and the speed of the mobile object increases and reaches a third speed that is less than the first speed, generates a brake preload.

### [Form 8]

The driving assistance device according to Form 1, wherein
the speed control unit, after the predetermined period has elapsed, in a case that the predetermined condition is not satisfied, sets an upper limit of the driving force higher as the elapsed time since the predetermined period ended is longer and limits the driving force to the upper limit.

What is claimed is:

1. A driving assistance device configured to perform driving assistance for a mobile object, comprising:
an automatic stopping control unit configured to stop the mobile object by applying brake force in a case that a collision between the mobile object and an obstacle around the mobile object is predicted, and keeps the mobile object stationary for a predetermined period starting from the moment the mobile object is stopped; and
a speed control unit configured to, after the predetermined period has elapsed, in a case that a predetermined condition is satisfied, control at least one of a driving force and a brake force of the mobile object to limit a speed of the mobile object to a first speed,
wherein the predetermined condition indicates that an accidental pedal depression has occurred, the accidental pedal depression being an operation by a driver of the mobile object mistakenly depressing an accelerator with the intention of depressing a brake pedal.

2. The driving assistance device according to claim 1, wherein
the speed control unit is configured to, after the predetermined period has elapsed, in a case that the predetermined condition is satisfied and a speed of the mobile object is between the first speed and a second speed lower than the first speed, set an upper limit of the driving force smaller as the speed of the mobile object increases and limit the driving force to the upper limit.

3. The driving assistance device according to claim 2, wherein
the speed control unit is configured to, after the predetermined period has elapsed, in a case that the predetermined condition is satisfied and the speed of the mobile object is less than the second speed, limit the driving force to a predetermined maximum upper limit.

4. The driving assistance device according to claim 2, wherein
the speed control unit is configured to, after the predetermined period has elapsed, in a case that the predetermined condition is satisfied and the speed of the mobile object is less than the second speed, keep the driving force constant.

5. The driving assistance device according to claim 1, wherein
the speed control unit is configured to, after the predetermined period has elapsed, in a case that the predetermined condition is satisfied and the mobile object is on a downhill slope, apply the brake force to the mobile object to limit the speed of the mobile object to the first speed.

6. The driving assistance device according to claim 5, wherein
the speed control unit is configured to, after the predetermined period has elapsed, in a case that the predetermined condition is satisfied, the mobile object is on a downhill slope, and the speed of the mobile object exceeds the first speed, apply brake force to the mobile object that is greater as the speed of the mobile object is greater.

7. The driving assistance device according to claim 5, wherein
the speed control unit, after the predetermined period has elapsed, in a case that the predetermined condition is satisfied, the mobile object is on a downhill slope, and the speed of the mobile object increases and reaches a third speed that is less than the first speed, generates a brake preload.

8. The driving assistance device according to claim 6, wherein
the speed control unit, after the predetermined period has elapsed, in a case that the predetermined condition is satisfied, the mobile object is on a downhill slope, and the speed of the mobile object increases and reaches a third speed that is less than the first speed, generates a brake preload.

9. The driving assistance device according to claim 1, wherein
the speed control unit, after the predetermined period has elapsed, in a case that the predetermined condition is not satisfied, sets an upper limit of the driving force higher as the elapsed time since the predetermined period ended is longer and limits the driving force to the upper limit.

10. A driving assistance method for performing driving assistance for a mobile object, comprising:
stopping the mobile object by applying brake force in a case that a collision between the mobile object and an obstacle around the mobile object is predicted, and keeps the mobile object stationary for a predetermined period starting from the moment the mobile object is stopped,
controlling, after the predetermined period has elapsed, in a case that a predetermined condition is satisfied, at least one of a driving force and a brake force of the mobile object to limit a speed of the mobile object to a first speed,
wherein the predetermined condition indicates that an accidental pedal depression has occurred, the accidental pedal depression being an operation by a driver of the mobile object mistakenly depressing an accelerator with the intention of depressing a brake pedal.
